(19) United States
(12) Patent Application Publication
(10) Pub. No.: US 2019/0295740 A1
(43) Pub. Date: Sep. 26, 2019

(54) MECHANICALLY ROBUST FLEXIBLE HYBRID ELECTRODE

(71) Applicant: The Board of Trustees of the University of Illinois, Urbana, IL (US)

(72) Inventors: SungWoo Nam, Savoy, IL (US); Pilgyu Kang, Fairfax, VA (US); Chullhee Cho, Champaign, IL (US)

(73) Assignee: The Board of Trustees of the University of Illinois, Urbana, IL (US)

(21) Appl. No.: 16/357,722

(22) Filed: Mar. 19, 2019

Related U.S. Application Data
(60) Provisional application No. 62/645,840, filed on Mar. 21, 2018.

(51) Int. Cl. H01B 5/14; H01B 1/08; H01B 13/00; H01B 1/10; G01B 7/16

(52) U.S. Cl. CPC H01B 5/14; H01B 1/08; G01B 7/18; H01B 1/10; H01B 13/0036

(57) ABSTRACT

A mechanically robust flexible hybrid electrode comprises a polymeric substrate, one or more monolayers of a two-dimensional (2D) material on the polymeric substrate, and an electrically conductive film on the 2D material. The mechanically robust flexible hybrid electrode may exhibit a bending strain to failure of at least about 12%. A method of making a flexible hybrid electrode may comprise transferring a monolayer comprising a 2D material to a polymeric substrate. After transferring one or more of the monolayers to the polymeric substrate, an electrically conductive film may be formed on the one or more monolayers, thereby forming a mechanically robust flexible hybrid electrode.

### RELATED APPLICATION

The present patent document claims the benefit of priority under 35 U.S.C. § 119(e) to U.S. Provisional Patent Application No. 62/645,840, filed on Mar. 21, 2018, which is hereby incorporated by reference in its entirety.

### FEDERALLY SPONSORED RESEARCH OR DEVELOPMENT

This invention was made with government support under grant numbers CMMI-1554019 awarded by the National Science Foundation, NNX16AR56G and 80NSSC17K0149 awarded by the National Aeronautics and Space Administration, and B617420 and B622092 awarded by the U.S. Department of Energy. The government has certain rights in the invention.

### TECHNICAL FIELD

The present disclosure is related generally to flexible electronics and more particularly to a strain-tolerant, mechanically robust hybrid electrode for flexible electronic devices.

### BACKGROUND

Due to their excellent electrical conductivity, metal-based electrodes or contacts are essential components in conventional rigid electronics, and they are being incorporated into flexible electronic devices as well. For example, gold thin films deposited on polydimethyl siloxane (PDMS) have been explored for a variety of flexible electronic device applications, such as sensitive electronic skin and microelectrodes for neural interfaces in biomedical engineering. In practice, the performance and applicability of such flexible devices are limited by a number of factors, including unstable electrical contacts and crack development or fracture failures at the interfaces under bending, twisting or repeated cyclic loadings, leading to reduced electrical conductivity and/or delamination failure. Metallic materials often exhibit low intrinsic fracture strains (e.g., <2%) and high cycle fatigue at low strain levels, which may result in a significant degradation of device performance after repeated operating cycles. Ideally, flexible electronic devices may be designed to undergo repeated and large strains without suffering from impaired electrical conductivity and without a significant increase in stiffness of the device.

### BRIEF SUMMARY

A mechanically robust flexible hybrid electrode comprises a polymeric substrate; one or more monolayers of a two-dimensional material on the polymeric substrate; and an electrically conductive film on the two-dimensional material. The mechanically robust flexible hybrid electrode can exhibit a bending strain to failure of at least about 12%.

A method of making a flexible hybrid electrode comprises transferring a monolayer comprising a two-dimensional material to a polymeric substrate, and, after transferring one or more of the monolayers to the polymeric substrate, depositing or laminating an electrically conductive film on the one or more monolayers. Thus, a mechanically robust flexible hybrid electrode including one or more monolayers of the two-dimensional material sandwiched between the electrically conductive film and the polymeric substrate is formed.

### BRIEF DESCRIPTION OF THE DRAWINGS

FIG. 1 is a cross-sectional schematic of an exemplary flexible hybrid electrode including a two-dimensional (2D) material sandwiched between an electrically conductive film and a polymeric substrate.

FIG. 2A is a perspective-view schematic of the flexible hybrid electrode of FIG. 1 under exposure to a bending stress.

FIG. 2B is a top-view schematic of the flexible hybrid electrode of FIG. 2A that reveals, along with the inset scanning electron microscope (SEM) image, that channeling and/or multiple cracking is the dominant cracking failure mode.

FIG. 2C is a top-view schematic of a conventional flexible electrode without a 2D material; the schematic reveals, along with the inset SEM image, that debonding and/or delamination is the dominant cracking failure mode.

FIG. 3 is a plot of change in electrical resistance as a function of applied bending strain for flexible conventional and hybrid electrodes including from 0 (“bare Au”) to 4 (“Au/4LG”) layers of graphene sandwiched between a gold film and a polydimethysiloxane (PDMS) substrate; the data illustrate the “electrically ductile” behavior of the flexible hybrid electrodes.

FIG. 4 is a plot of strain to failure as a function of the number of monolayers of graphene for both gold-based and copper-based flexible hybrid electrodes.

FIG. 5 presents a series of environmental scanning electron microscopy (ESEM) images showing crack generation as a function of bending strain for: (top images) a conventional flexible electrode including a gold film on a polymeric substrate without a 2D material in between (“bare gold electrode”); and (bottom images) a flexible hybrid electrode including a monolayer of graphene between the gold film and the polymeric substrate (“single-layer graphene integrated gold electrode”).

FIG. 6 compares crack width as a function of bending strain for a bare gold electrode and a single-layer graphene integrated gold electrode; the inset images depict crack width at a bending strain of 13.86%.

FIG. 7 compares representative domain size as a function of bending strain for a bare gold electrode and a single-layer graphene integrated gold electrode.

FIG. 8 shows different cracking modes and crack density observed for bare copper (left), single-layer graphene integrated copper (middle), and double-layer graphene integrated copper (right) regions on a polymeric substrate.

FIG. 9 shows resistance as a function of translation distance measured during bend tests carried out as shown in the inset for gold electrodes including from 0 to 4 monolayers of graphene.

FIG. 10 shows resistance as a function of twist angle measured during tests conducted in twist-strain driven mode as shown in the inset for gold electrodes including from 0 to 4 monolayers of graphene.

FIG. 11 shows resistance as a function of number of cycles as determined from a fatigue test (up to 10,000 cycles at a bending strain of 11%) of a double-layer graphene integrated gold electrode.

FIG. 12 shows normalized optical transmittance as a function of wavelength as determined by UV-Vis spectroscopy measurements on PDMS substrates including one-, two-, and four-monolayers of graphene (labeled 1L, 2L and 4L Graphene, respectively) prepared in a transfer process.

FIG. 13 shows Raman spectroscopy data for PDMS substrates with one-, two-, and four-monolayers of graphene (labeled 1L, 2L and 4L Graphene, respectively) prepared in a transfer process.

FIG. 14 shows bright and dark field optical microscope images of a polymeric substrate with and without an overlying 2D material monolayer/multilayer after etching away a deposited electrically conductive metal film.

### DETAILED DESCRIPTION

A novel electrode architecture that allows a significant enhancement in the mechanical robustness of flexible electronic devices is described in this disclosure. By incorporating a two-dimensional material between an electrically conductive film and a polymeric substrate, a mechanically-robust flexible hybrid electrode or electrical contact with superior electromechanical performance can be realized. This novel electrode architecture can be incorporated into a variety of flexible electronic devices, ranging from bendable displays and solar cells to skin sensors and other biomedical components.

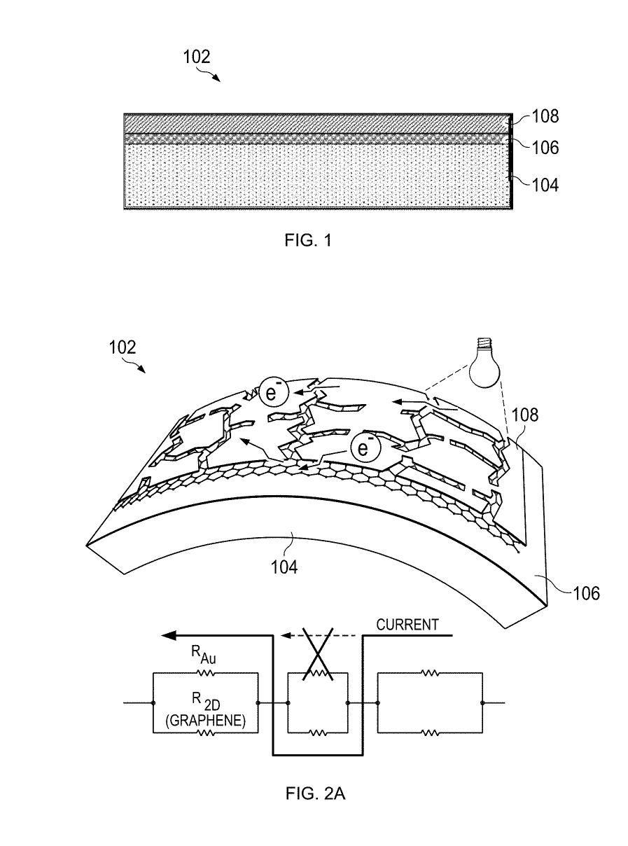

FIG. 1 shows a cross-sectional schematic of a mechanically robust flexible hybrid electrode 102. The hybrid electrode 102 includes a flexible polymeric substrate 104, at least one monolayer of a two-dimensional (2D) material 106 on the polymeric substrate 104, and an electrically conductive film 108 comprising a metal on the 2D material. The 2D material 106 may function as a resilient and low-friction interface to diminish the impact of out-of-plane (i.e., through-thickness) cracking when the electrically conductive film 108 is flexed. Accordingly, the presence of one or more monolayers (preferably at least two monolayers) of the 2D material 106 may improve the bending strain tolerance of the hybrid electrode 102.

The 2D material 106 may comprise graphene, boron nitride, silicene, germanane, phosphorene, and/or a chalcogenide represented by MX₂, where M is a transition metal atom and X is a chalcogen atom, such as molybdenum disulfide, or MoS₂. Generally speaking, the 2D material 106 includes an atomic or molecular species that repeats in (only) two dimensions, such that a monolayer of the 2D material (or, equivalently, a monolayer comprising the 2D material) has a sheet-like atomic or molecular structure. For example, graphene comprises a single layer of sp²-bonded carbon atoms. Graphene (0.34 nm thick) is an excellent candidate for use as the 2D material due to its relatively high fracture strain (˜25%, exfoliated), low bending rigidity (˜1.8 eV) and high electrical mobility (˜10⁴ cm²V⁻¹s⁻¹).

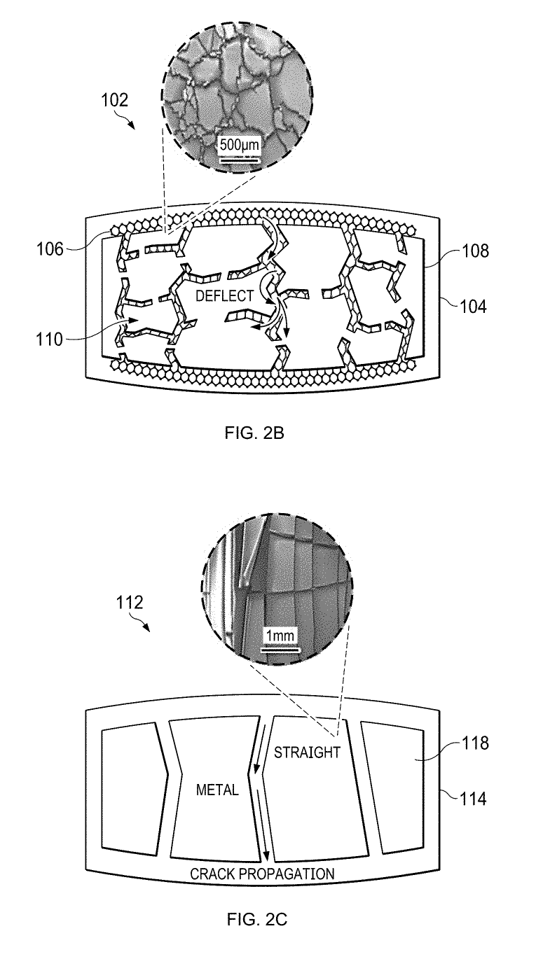

FIGS. 2A and 2B illustrate how crack propagation in the electrically conductive film 108 may be altered by the presence of the 2D material 106, allowing electrical conductance to be maintained to higher strains. FIG. 2A shows a perspective view of an exemplary flexible hybrid electrode 102 undergoing bending. FIG. 2B is a top-view schematic of the bent hybrid electrode 102 of FIG. 2A showing typical cracking behavior and an irregular cracking pattern 110, complemented by the scanning electron microscope (SEM) image in the inset. In contrast, FIG. 2C provides a top-view schematic and corresponding SEM image of an exemplary bent electrode 112 that does not include a 2D material between the conductive film 118 and polymeric substrate 114, such that different cracking behavior is obtained during bending. Clearly, the 2D material 106 can play a key role in modifying the dominant cracking failure mode from debonding and delamination (FIG. 2C) to what may be described as multiple cracking and channeling (FIG. 2B). Notably, most cracks propagate along straight paths in the electrode 112 of FIG. 2C, indicative of brittle fracture along the crystallographic plane. In contrast, in the flexible hybrid electrode 102, cracks propagate nonlinearly with local fluctuations in the crack propagation direction so as to form the irregular cracking pattern shown in FIG. 2B.

In the flexible hybrid electrode 102, cracks induced in the electrically conductive film 108 during deformation (e.g., bending, twisting) may propagate toward the 2D material 106 and be arrested or deflected in a highly nonlinear fashion, leading to an irregular fracture pattern 110 that allows regions (or “domains”) of the electrically conductive film 108 to remain interconnected, as illustrated by the circuit schematic of FIG. 2A. Crack arrest and deflection from a monolayer of graphene or another 2D material 106 may delay or restrain crack tip propagation and promote random multiple cracking behaviors. The continuous creation of a new crack propagating ahead of a crack front due to this crack arrest/deflection behavior can release much more strain compared to straight cracking behavior. It therefore appears that higher energy may be required to propagate a crack to fracture in the flexible hybrid electrode 102 described in this disclosure. This energy absorbing mechanism, which is linked to the presence of the 2D material 106, may contribute to delayed crack propagation and the prevention of catastrophic electrical failure.

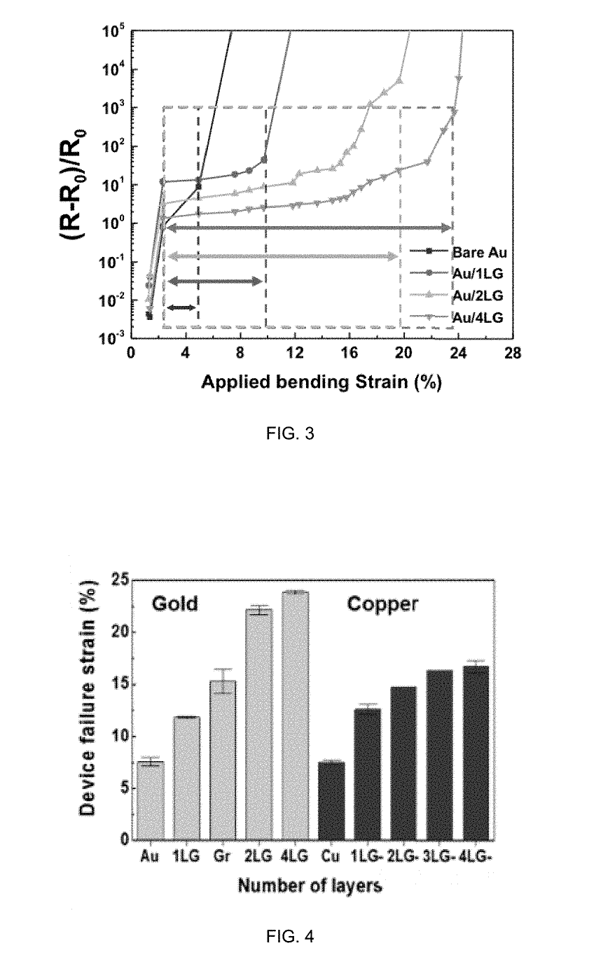

Experiments discussed in greater detail below reveal that the robustness or strain tolerance of the hybrid electrode 102 increases with an increasing number of monolayers of the 2D material 106. In other words, an increased strain tolerance of the flexible hybrid electrode 102 is linked to an increased thickness of the 2D material 106. Insertion of multiple monolayers (or “multilayers”) of the 2D material may result in what may be described as electrically ductile behavior of the flexible hybrid electrode, as illustrated by the data of FIG. 3. Notably, the electrical resistance of a flexible hybrid electrode comprising multilayers of the 2D material increases gradually with rising bending strain, in contrast to the abrupt increase observed with a bare metal electrode that does not include a 2D material.

For example, referring to FIG. 4, a flexible hybrid electrode 102 comprising a gold film on one or more monolayers of graphene shows up to 300% higher bending strains at failure (ε_{failure}˜23.85%) compared to a “bare Au” electrode including a gold film deposited directly on the polymeric substrate (ε_{failure}˜7.59%), as discussed below. In addition, a flexible hybrid electrode 102 including four graphene layers between the gold film and the polymeric substrate exhibits a 200% higher bending strain at failure than a flexible hybrid electrode with only a single layer of graphene between the gold film and the polymeric substrate (ε_{failure}˜12.61%).

A similar thickness-dependent enhancement of strain tolerance is obtained when a copper film is used in lieu of a gold film. Referring again to FIG. 4, flexible hybrid electrodes including copper on one or more monolayers of graphene show as much as a 220% improvement in strain tolerance (ε_{failure}˜16.69%) compared to a “bare Cu” electrode comprising a copper film deposited directly on the polymeric substrate (ε_{failure}˜7.54%), and the strain tolerance increases with each additional monolayer. Possibly contributing to the improvement in strain tolerance shown in FIG. 4 are the higher stress intensity factors and fracture toughness values achievable with a stack of two or more monolayers (multilayers) compared to a single monolayer. In addition, slippage or sliding between the multilayers may help to accommodate bending strain and to impede failure. Generally speaking, the flexible hybrid electrode may be able to accommodate at least about 12% bending strain prior to failure, at least about 15% bending strain prior to failure, at least about 18% bending strain prior to failure, and/or at least about 20% bending strain prior to failure dependent on the number of 2D layers. A maximum bending strain to failure may be about 30%, or greater, depending on the number of monolayers. All of these values are well beyond the bending strain values (e.g., about 7-8%) achievable from electrodes including only metal films on polymer substrates without an intervening 2D material.

Since the strain tolerance increases with additional monolayers of the 2D material 106, it is practically preferred the flexible hybrid electrode 102 includes at least two monolayers of the 2D material 106 between the electrically conductive film 108 and the polymeric substrate 104 due to any defects/damage to the 2D material that may occur during the growth or transfer process. The flexible hybrid electrode 102 may also include at least three, at least four, and up to ten monolayers of the 2D material 106 so as to enhance the strain tolerance. In terms of actual dimensions, the thickness of the 2D material, including all of the one or more monolayers, may lie in a range from about 0.3 nm to about 5 nm with graphene, or from about 0.7 nm to about 10 nm with molybdenum disulfide monolayers. If the thickness of the 2D material 106 is too large (e.g., beyond ten monolayers), the stiffness of the hybrid electrode may increase to an unacceptable level to maintain the desired flexibility.

Given the above results with copper and gold films, it is apparent that the approach of inserting a 2D material 106 between an electrically conductive film 108 and a polymeric substrate 104 to enable electrical conductivity to be maintained over large bending strains is not limited to particular metals. The electrically conductive film 108 may comprise an electrically conductive material comprising one or more of the following metals: Cu, Au, Ag, Al, Mo, Zn, Ni, Fe, Pd, Pt, W, Sn, Ti, Mg, Co and In. The electrically conductive film 108 may be optically transparent for some applications. In such an embodiment, the electrically conductive film 108 may comprise indium-tin oxide (ITO) or another conductive transparent oxide. Typically, the thickness of the electrically conductive film 108 lies in a range from about 50 nm to about 5 microns and is more typically in the range from about 200 nm to about 2 microns, or from about 200 nm to about 800 nm. A large thickness is desirable to maximize electrical conductivity, but at very high thicknesses (e.g., 10 microns or higher) delamination of the electrically conductive film is possible during exposure to large bending stresses. In some cases, it may be beneficial to deposit an adhesion layer prior to depositing the electrically conductive film 108. Typically, the adhesion layer comprises a metal such as titanium. The adhesion layer may have a thickness of about 5-20% of the thickness of the electrically conductive film 108.

As mentioned above, other 2D materials 106, such as molybdenum disulfide (MoS₂), hexagonal boron nitride (hBN), and/or phosphorene, can be incorporated into the flexible hybrid electrode 102. Bending experiments reveal that MoS₂ (a semiconductor with good fracture toughness) exhibits similar cracking behavior to graphene when employed as the 2D material 106. For example, a flexible hybrid electrode comprising a gold electrically conductive film on MoS₂ (from one to five monolayers) on a polymeric substrate exhibits about 190% higher bending strain at failure (ε_{failure}˜19%) than a bare gold electrode (ε_{failure}˜10%). The lower improvement compared to the graphene example mentioned above can be attributed to the lower intrinsic conductivity of the MoS₂ layer(s).

The polymeric substrate 104 of the flexible hybrid electrode 102 may comprise a polymer, such as an elastomer. Preferably, the polymeric substrate 104 may be stretched or deformed and returned to its original shape without substantial permanent deformation. Useful elastomers may include, but are not limited to, thermoplastic elastomers, styrenic materials, olefinic materials, polyolefin, polyurethane thermoplastic elastomers, polyamides, synthetic rubbers, PDMS, polybutadiene, polyisobutylene, poly(styrene-butadiene-styrene), polyurethanes, polychloroprene and silicones. In some embodiments, an elastomeric stamp comprises an elastomer. Exemplary elastomers include silicon-containing polymers such as polysiloxanes including poly(dimethyl siloxane) (e.g., PDMS and h-PDMS), poly(methyl siloxane), partially alkylated poly(methyl siloxane), poly(alkyl methyl siloxane) and poly(phenyl methyl siloxane), silicon-modified elastomers, thermoplastic elastomers, styrenic materials, olefinic materials, polyolefin, polyurethane thermoplastic elastomers, polyamides, synthetic rubbers, polyisobutylene, poly(styrene-butadiene-styrene), polyurethanes, polychloroprene and silicones.

The new electrode architecture not only modifies the dominant cracking failure mode to allow electrical conductivity to be maintained under high strains, but also allows for failure prediction during device usage. Because the electrical resistance of the flexible hybrid electrode rises gradually with strain—instead of exponentially as with bare metal films on polymers—electrical resistance may be reliably monitored during deformation to prevent sudden catastrophic failures. Accordingly, the electrical resistance of the flexible hybrid electrode may be monitored during use to ensure mechanical and electrical integrity of the device, and also to allow for failure prediction at high strains and an alert for the maintenance/replacement before a complete device failure.

The flexible hybrid electrode may be advantageously utilized in a flexible (non-rigid) electronic device which is subjected to bending, stretching, folding, and/or twisting during use, such as a flexible display, solar cell, light-emitting diode, wearable sensor, or biomedical component.

A method of making the flexible hybrid electrode is also set forth in this disclosure. The method includes transferring a monolayer comprising a 2D material onto a polymeric substrate. After one or more of the monolayers have been transferred, an electrically conductive film is formed (e.g., deposited or laminated) on the one or more monolayers. As described below, the formation of the electrically conductive film takes place at a relatively low temperature to avoid damage to the polymeric substrate. Thus, a mechanically robust flexible hybrid electrode 102 comprising one or more monolayers of a 2D material 106 sandwiched between the electrically conductive film 108 on the polymeric substrate 104 is formed. The flexible hybrid electrode 102 formed as described herein may have any of the characteristics set forth in this disclosure.

The transferring of the monolayer may entail stamping or solution transfer, or another method capable of transferring a 2D material such as graphene to the polymeric substrate without damage. Since 2D materials such as graphene and MoS₂ are typically synthesized on a growth substrate (e.g., by chemical vapor deposition (CVD)), a stamping process for transfer of the monolayer may involve transfer of both the monolayer of the 2D material and the growth substrate, followed by etching to remove the growth substrate. A suitable stamping process may include a first step of contacting a growth substrate comprising a monolayer of a 2D material with a polymeric stamp to attach the growth substrate thereto. After attachment, the polymeric stamp is moved relative to the polymeric substrate to a desired location for transfer of the monolayer; and the growth substrate is released from the polymeric stamp, thereby transferring the monolayer comprising the two-dimensional material onto the polymeric substrate. The growth substrate is then removed by chemical etching or another suitable process.

Given the results described above showing an improvement in strain tolerance for a flexible hybrid electrode that includes multiple monolayers of the 2D material, it may be advantageous to transfer two or more of the monolayers prior to depositing the electrically conductive film. For example, three or more, four or more, five or more, and up to ten of the monolayers may be transferred before the electrically conductive film is deposited.

Typically, the electrically conductive film is formed on the one or more monolayers using a physical vapor deposition method, such as electron-beam deposition, thermal evaporation, or sputtering. Preferably, the electrically conductive film may be formed (e.g., deposited, laminated or otherwise fabricated) on the one or more monolayers at a temperature below that at which the polymeric substrate might deteriorate or otherwise be negatively impacted. A suitable temperature for formation of the electrically conductive film may lie in a range from about 10° C. to about 100° C., and more typically from about 20° C. to about 60° C. Prior to depositing the electrically conductive film, it may be beneficial to deposit an adhesion layer on the one or more monolayers to promote adhesion between the electrically conductive film and the two-dimensional material. When present, the adhesion layer may have a thickness of about 5-20% of the thickness of the electrically conductive film. The adhesion layer may be deposited by a physical vapor deposition process as set forth above, and may comprise a metal such as titanium.

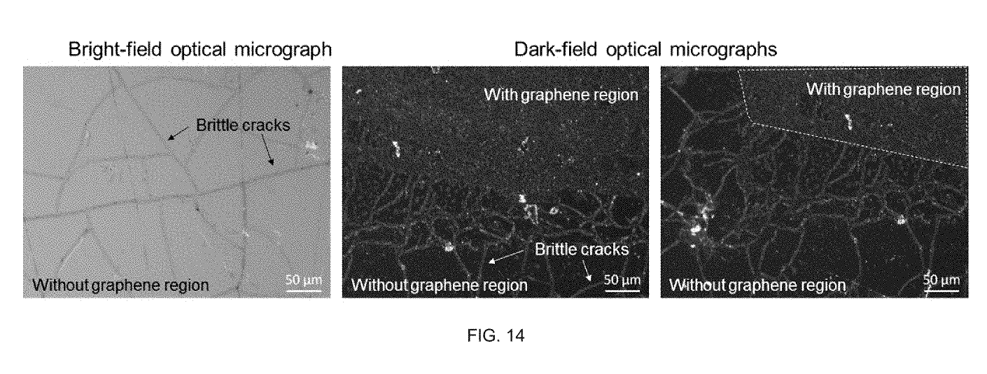

Advantageously, the one or more monolayers of 2D material may inhibit formation of a brittle polymeric layer on the polymeric substrate during deposition of the electrically conductive film, further enhancing the strain tolerance. As noted above, it is preferred that the electrically conductive metal film is formed at a temperature at which the polymeric substrate does not significantly deteriorate. However, during metal film deposition on polymeric substrates, even via electron beam evaporation or thermal evaporation which are associated with low substrate temperatures, an additional brittle cross-linking layer (“skin layer”) may form at the surface of the polymeric substrate due to hardening induced by radiation emitted from the source. It has been discovered that the one or more monolayers of the 2D material may inhibit or prevent the formation of this brittle polymeric layer, which is associated with premature cracking. FIG. 14 shows bright/dark field optical microscope images after etching away the electrically conductive metal film. The images provide evidence that there is no brittle cracking propagated in areas of the polymer substrate that include a 2D material, while there is extensive cracking in areas without the 2D material.

After deposition, the electrically conductive film and some or all of the underlying layers (optional adhesion layer, 2D material, and/or polymeric substrate) may be patterned using methods known in the art to form a flexible hybrid electrode having a predetermined shape.

### Examples

### Characterization of Cracking Behavior

When a flexible hybrid electrode including an electrically conductive (e.g., metal) film on a polymeric substrate with a 2D material sandwiched in between is subjected to mechanical loads, cracks typically develop within the electrically conductive film, which may have a lower intrinsic fracture strain than the polymeric (e.g., elastomeric) substrate. Cracks may initiate and propagate rapidly throughout the entire metal film thickness. When such cracks reach the interface, the crack propagation can have alternative failure modes. Cracks can either run along the interface resulting in metal film delamination or can be arrested and new cracks may initiate at another place upon additional loadings.

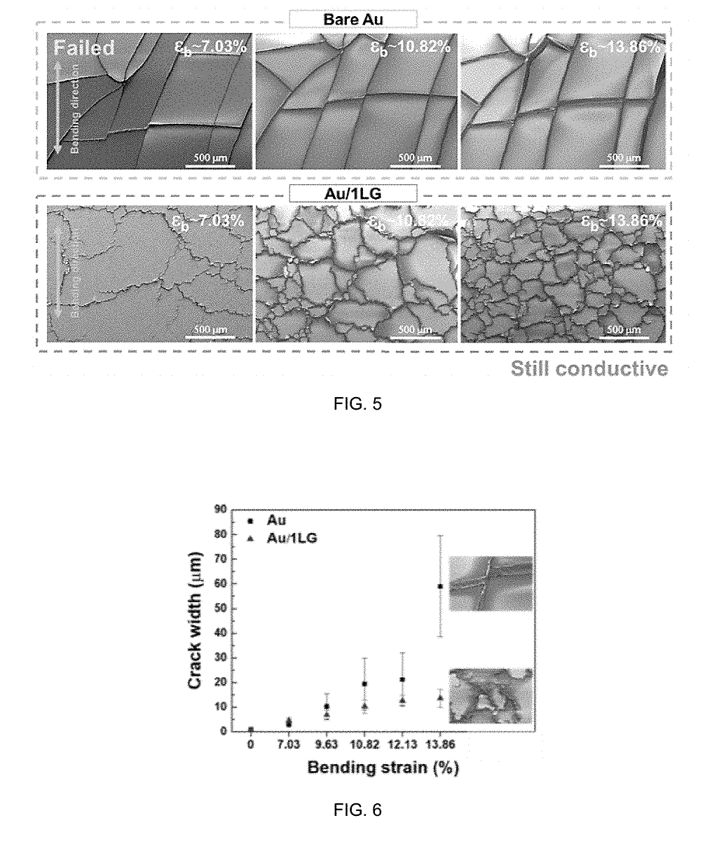

Crack generation for various bending strains is qualitatively characterized and quantitatively analyzed via in situ bending tests and environmental scanning electron microscopy (ESEM). FIG. 5 provides a comparison of crack growth in a conventional flexible electrode comprising a gold film on a polymeric substrate (“bare Au,” top) and a flexible hybrid electrode comprising a gold film on a polymeric substrate with a single monolayer of graphene in between (“Au/1 LG,” bottom) in response to bending strains up to about 14%. The arrow on the left hand side indicates the bending direction. The result, where most or all cracks propagate along straight paths in the bare Au electrode and most or all cracks in the flexible hybrid electrode propagate along nonlinear paths, can be observed in FIG. 5 and is shown schematically in FIGS. 2B and 2C. The behavior of the flexible hybrid electrode is consistent with mixed-mode fracture. When cracks grow in non-uniform stress fields, the path of the fracture is generally curved (nonlinear).

Referring again to the series of ESEM images in FIG. 5, the crack deflection or kink angles of the Au/1 LG electrode may be much larger than those of the bare Au electrode. Crack deflection is defined as the twist and tilt of the crack front between microstructural elements which leads to an increase of fracture toughness at the crack tip. This crack deflection changes the value of stress intensity factor compared to the case of straight crack propagation. While the bare Au electrode shows a complete electrical disconnection at a bending strain of 7%, the Au/1 LG electrode maintains its electrical conductivity at a bending strain of 14%. As can be observed in FIG. 5, straight crack propagation in the bare Au electrode tends to create large isolated or disconnected domains, and the crack density is already saturated at bending strain of about 7%. In contrast, the crack density progressively increases with bending strain in the Au/1 LG electrode, and the cracks tend to be created in smaller domains, where deflected crack edges create a polygonal interconnected network and allow electrical conductivity to be maintained.

Quantitative analysis of crack generation as a function of bending strain further supports the hypothesis that higher strain energy is required for crack propagation in the flexible hybrid electrodes. In a set of experiments, twenty different cracks are continuously monitored at five different bending strains for each sample (bare Au electrode and Au/1 LG electrode). FIG. 6 plots crack width as a function of applied bending strain for both electrodes; black dots denote the results of the bare Au and the gray triangles indicate Au/1 LG results.

Cracks in the bare Au electrode tend to grow larger and more rapidly than cracks in the Au/1 LG electrode as bending strain is increased. The bare Au electrode subjected to a bending strain of 7.03% fails with an average crack width of 10.24 μm; the bare Au electrode subjected to a bending strain of 13.86% fails with a much larger average crack width of 59.06 μm. Significant charging effects due to the large crack-width growth indicate delamination of the gold film from the substrate (FIG. 6 inset).

In contrast, cracks in the Au/1 LG electrode develop much more slowly and gradually without an observance of the apparent charging effect. The average crack width at a bending strain of 12.13% is approximately 12.63 μm. This crack width slightly exceeds the crack width at which the bare Au electrode fails (˜10.24 μm) at a bending strain of about 7%, but the Au/1 LG electrode still shows the capability of electrical conductance.

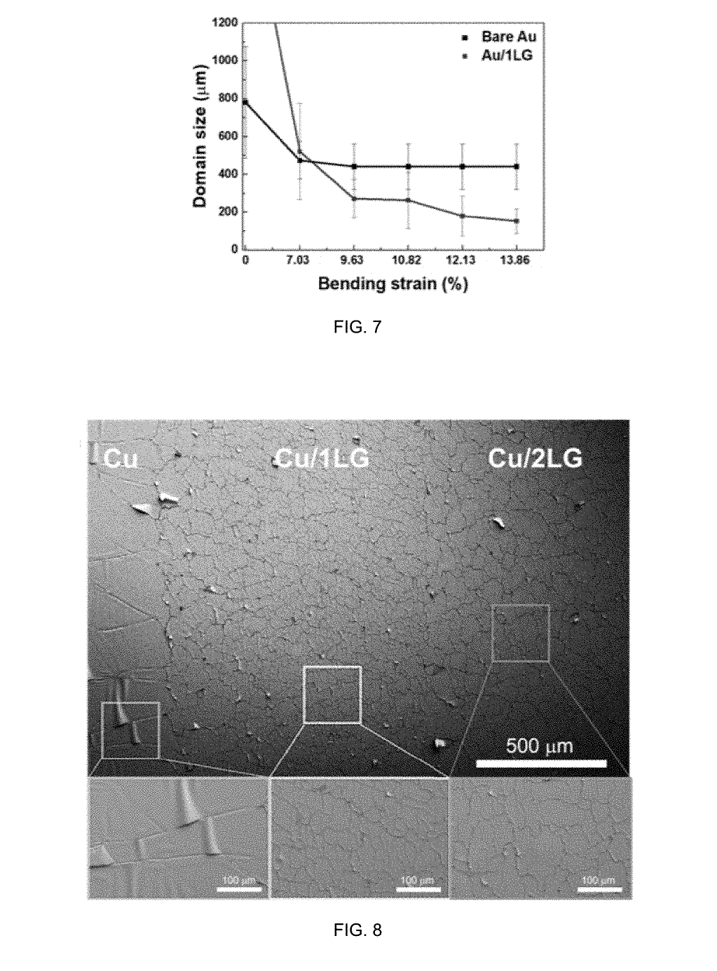

In addition, straight crack propagation in the bare Au electrode creates large isolated-island domains compared to the much smaller interconnected domains created in the Au/1 LG electrode. The average domain size is estimated as the root mean square of the diagonal lengths of all the domains from the ESEM images. Referring to FIG. 7, the average domain size measured in the Au/1 LG electrode (˜198.67 μm) at 12.13% of bending strain is approximately one-third of the average domain size measured in the bare Au electrode (˜519.92 μm) at the same strain. Smaller domains with a large degree of deflected crack edges, such as observed in the Au/1 LG electrode, are more conducive to creating potential conductive paths across the electrode (e.g., via crack bridging between adjacent domains of a polygonal interconnected network) than larger domains with straight crack edges, as observed in the bare Au electrode. Overall, two salient toughening mechanisms can be identified: crack deflection/arrest and crack bridging.

Distinctly different cracking behaviors are also observed between bare and hybrid electrodes for copper-based electrodes. FIG. 8 shows different cracking behaviors from different electrode regions on a polymeric substrate (bare Cu; Cu on a monolayer of graphene (Cu/1 LG); and Cu on two monolayers of graphene (Cu/2LG). Under the same applied strain, straight crack propagation results in delamination in the bare Cu region (far left), while higher channeling cracking density with deflected crack edges is observed in the Cu/1 LG area (middle) and the Cu/2LG area (far right), which indicates more capability to accommodate a higher strain.

### Strain-Dependent Electromechanical Behavior

The strain-dependent electromechanical behavior of a flexible hybrid electrode having different numbers of monolayers of a 2D interfacial material is compared with the behavior of a bare metal (e.g., Au) electrode with no underlying 2D material. In these examples, multiple monolayers of graphene are produced by repetitively carrying out a stamping transfer process on a polymeric substrate before deposition of an electrically conductive film comprising, in these experiments, gold or copper. The quality of the transferred 2D material and the number of layers obtained on a polymeric (e.g., PDMS) substrate are analyzed by two non-destructive optical analysis techniques, UV-Vis spectroscopy and Raman spectroscopy, as discussed below.

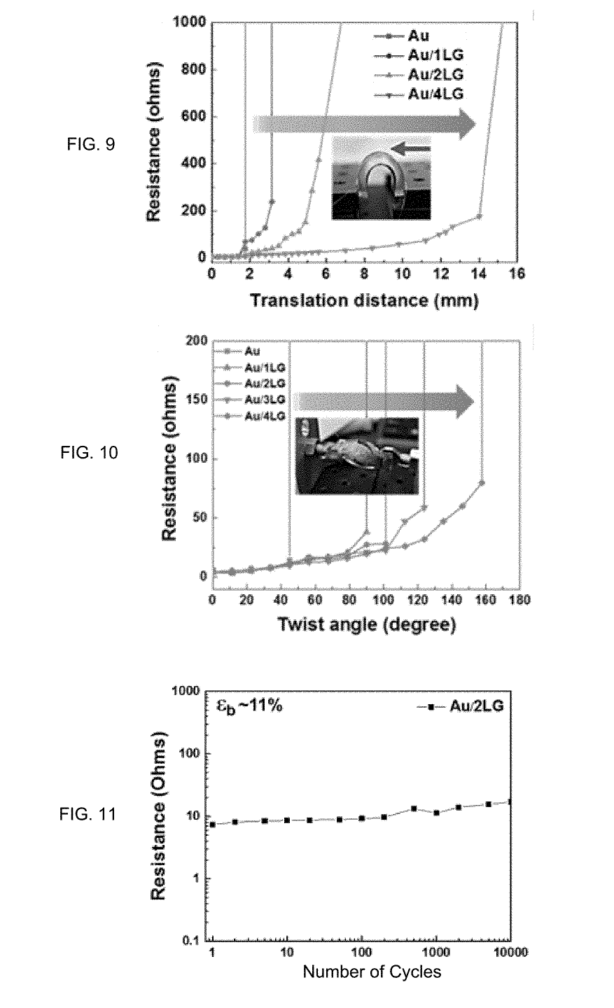

Tensile bending strains are applied to the flexible hybrid electrodes by changing the translation distance using a linear translation stage, as shown in the inset of FIG. 9. As the translation distance increases, the radius of curvature of the flexible hybrid electrode (and thus the electrically conductive film and the underlying 2D material) decreases. The radius of curvature (φ was measured via side-view image analysis and tensile bending strain was determined based on the analytical formula of εₜₑₙₛᵢₗₑ=t/2ρ, where t is the thickness of the conductive film and the underlying 2D material. The electrical resistance of the flexible hybrid electrode is continuously measured as a function of translation distance, as shown by the data of FIG. 9. The electrical resistance of the flexible electrode is measured to range from a few ohms to the order of a mega-ohm (10⁶Ω) for the device failure characterization.

As noted above, the electrical resistance of a flexible hybrid electrode comprising multilayers of the 2D material increases gradually with rising bending strain, in contrast to the abrupt increase observed with a bare metal electrode. This result is consistent with the cracking behavior observation of a higher crack density with smaller domains in the flexible hybrid electrode, and a lower crack density with larger domains in the bare metal electrode.

The extended strain values for different thicknesses of the 2D material (Au/1 LG, Au/2LG, Au/4LG) are compared for a change in electrical resistance of three orders of magnitude (>10³Ω) relative to the initial resistance value measured for the respective flexible hybrid electrode. It is noted that the electrically conductive film may no longer be a better conductor than a bare graphene monolayer when the resistance change is above this three orders of magnitude limit.

The Au/4LG flexible hybrid electrode shows more than 300% extended strain tolerance before a sudden soar in its resistance compared to the strain tolerance exhibited by the bare Au electrode. The change in resistance as a function of the applied bending strain shown in FIG. 3 demonstrates that increasing electrically ductile behavior is obtained with more multilayers of the 2D material. Quantitative analysis of the thickness dependence of the 2D material to strain tolerance is shown in FIG. 4 and was described above. The Au/4LG electrode device shows more than 300% higher bending strains to failure (ε_{failure}˜23.85%) compared to the bare Au electrode device (ε_{failure}˜7.59%). In addition, the Au/4LG electrode device exhibits a 200% higher bending strain to failure compared to the Au/1 LG electrode device (ε_{failure}˜12.61%).

To further explore the electrical reliability of the electrodes under different strain-driven modes, the strain-dependent electrical resistance is characterized upon twisting deformation and cyclic operation. Consistent results are observed in electrical measurement utilizing a twisting test as shown in the inset of FIG. 10. The electrical resistance of the bare Au electrode changes by more than three orders of magnitude after exposure to 45 degrees of twisting, as shown by the data of FIG. 10. However, the Au/2LG electrode sustains its reliable electrical performance until exposure to approximately 101 degrees of twisting. Even further, Au/4LG can sustain up to about 160 degrees of twisting with less than an order of magnitude change in the integrity of electrical performance. In the case of twisting, the effect of a partial resistance recovery due to crack re-connection between adjacent polygonal network crack domains may occur more than in the case of bending, where the Poisson's effect may lead to crack re-connection during the transition between Mode I (normal, in-plane) and Mode II (shear).

Mechanical robustness under repeated mechanical strains is also considered to be an important consideration in the practical application of flexible or wearable electronics. The mechanical robustness a flexible hybrid electrode including a gold film on a PDMS substrate with a double layer of graphene in between is evaluated. Plotted in FIG. 11 is the electrical resistance measured for up to 10,000 cycles of cyclic strains. The electrical resistance of the electrode is monitored as a function of the number of bending-relaxation cycles. A half-of-average device failure strain of the flexible hybrid electrode containing a double layer of graphene (Eb 11%) is chosen for the 10,000-cycle fatigue resistance test. The cyclic bending-releasing test demonstrates excellent electrical stability for a dynamic loading of 10,000 cycles, indicating reliable electrical performance. The total change of resistance is much lower than one order of magnitude. The strain-dependent electromechanical test results show that the conductance capability of gold may be extended significantly by the insertion of multilayers of graphene or another 2D material.

In addition, the above-described results show that crack propagation behavior as well as the dominant cracking failure mode may be altered via the insertion of a 2D material between the electrically conductive film and the flexible polymeric substrate, thereby extending the electrical capability of the flexible electrode to accommodate larger deformation. Due to the presence of the 2D material, the dominant cracking failure mode may shift from delamination/debonding to channeling/multiple cracking with deflected crack edges, such that conductive paths are generated via crack bridging and the strain tolerance of the flexible hybrid electrode is enhanced. The results described above further reveal that the improvement in strain tolerance can be increased by increasing the thickness (number of monolayers) of the 2D material.

### Flexible Hybrid Electrode Preparation

A single layer (monolayer) of graphene is synthesized via chemical vapor deposition (CVD) on a catalytic copper foil and then directly stamped onto a flexible polymeric substrate (PDMS in this example), followed by immersion in a copper etchant to remove the foil. The laminating transfer method is applied multiple times to artificially stack up graphene layers followed by a complete etching of the catalytic copper film and multiple cleaning steps.

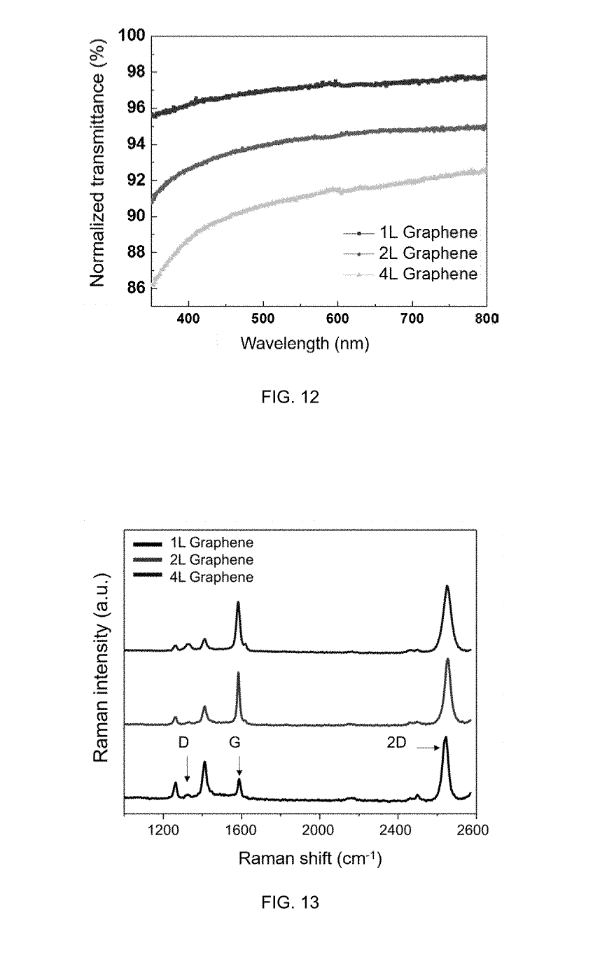

The quality of transferred graphene and the number of layers obtained on the polymeric substrate are analyzed by two non-destructive optical analysis techniques: UV-Vis spectroscopy (FIG. 12) and Raman spectroscopy (FIG. 13). The transmittance value from each sample are normalized by the transmittance of the polymeric substrate measured on the same device. The numbers of transferred graphene layers are then determined based on the normalized transmittance at wavelength 550 nm using Eq. (1).

$$T ( \% ) = {( 1 - \frac{1.13 π α N}{2} )}^{- 2} , \\ α \approx 1 \text{/} 137 ( fine \text{-} structure constant ) \qquad ( 1 )$$

The increments in the transmittance results clearly reveal that a deterministic number of graphene layers are obtained on the polymeric substrate by the transfer method. The Raman spectroscopy analysis reveals the quality of the different number of graphene layers. The negligible intensity of the D peak from the graphene layer at around 1350 cm⁻¹ indicates there is no significant damage incurred during transfer. The peaks at around 1250 cm⁻¹ and just above 1400 cm⁻¹ are from the underlying PDMS substrate. In addition, changes in the intensity ratio between the G (˜1580 cm⁻¹) and 2D (˜2650 cm⁻¹) provide evidence for the multilayer graphene configuration.

After the transfer of multilayer graphene, as described above, a gold (Au) film (e.g., 200 nm in thickness) is deposited via electron beam deposition on the prepared n-graphene/PDMS substrate. Deposition may be aided by an adhesion layer (e.g., 20 nm in thickness) of titanium (Ti) deposited prior to the Au film. After deposition, the Au film may further undergo patterning methods known in the art to form a desired electrode shape or configuration, depending on the intended application.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A mechanically robust flexible hybrid electrode comprising:
a polymeric substrate;
one or more monolayers of a two-dimensional (2D) material on the polymeric substrate; and
an electrically conductive film on the 2D material.

2. The mechanically robust flexible hybrid electrode of claim 1, wherein the polymeric substrate comprises an elastomer.

3. The mechanically robust flexible hybrid electrode of claim 1, wherein the 2D material is selected from the group consisting of:
graphene, boron nitride, silicene, germanane, phosphorene, and a chalcogenide represented by MX₂, where M is a transition metal atom and X is a chalcogen atom.

4. The mechanically robust flexible hybrid electrode of claim 3, where M is molybdenum and X is sulfur, MX₂ being molybdenum disulfide.

5. The mechanically robust flexible hybrid electrode of claim 1 comprising from two to ten monolayers of the 2D material.

6. The mechanically robust flexible hybrid electrode of claim 5 comprising from two to four monolayers of the 2D material.

7. The mechanically robust flexible hybrid electrode of claim 1, wherein the electrically conductive film comprises a metal selected from the group consisting of: Cu, Au, Ag, Al, Mo, Zn, Ni, Fe, Pd, Pt, W, Sn, Ti, Mg, Co and In.

8. The mechanically robust flexible hybrid electrode of claim 1, wherein the electrically conductive film is optically transparent.

9. The mechanically robust flexible hybrid electrode of claim 8, wherein the electrically conductive film comprises indium-tin oxide (ITO).

10. The mechanically robust flexible hybrid electrode of claim 1, wherein the electrically conductive film has a thickness in a range from about 50 nm to about 5 microns.

11. The mechanically robust flexible hybrid electrode of claim 10, wherein the thickness is in the range from about 200 nm to about 800 nm.

12. The mechanically robust flexible hybrid electrode of claim 1, comprising a bending strain to failure of at least about 12%.

13. A flexible electronic device comprising the mechanically robust flexible hybrid electrode of claim 1.

14. The flexible electronic device of claim 13 being selected from the group consisting of: display, solar cell, light-emitting diode, wearable sensor, and biomedical component.

15. The flexible electronic device of claim 13 being configured for monitoring electrical resistance of the flexible hybrid electrode during use to allow for failure prediction at high strains.

16. A method of making a flexible hybrid electrode, the method comprising:
transferring a monolayer comprising a two-dimensional (2D) material to a polymeric substrate;
after transferring one or more of the monolayers to the polymeric substrate, forming an electrically conductive film on the one or more monolayers, thereby fabricating a mechanically robust flexible hybrid electrode.

17. The method of claim 16, wherein the transferring comprises stamping, the stamping comprising:
contacting a growth substrate comprising the monolayer with a polymeric stamp to attach the growth substrate and monolayer thereto;
after attachment, moving the polymeric stamp to a desired position relative to the polymeric substrate;
releasing the growth substrate from the polymeric stamp, thereby transferring the monolayer comprising the 2D material to the polymeric substrate; and
removing the growth substrate.

18. The method of claim 16, wherein two or more of the monolayers are transferred prior to depositing the electrically conductive film.

19. The method of claim 16, wherein the one or more monolayers comprising the 2D material inhibit formation of a brittle polymeric layer on the polymeric substrate during formation of the electrically conductive film.

20. The method of claim 16, further comprising, after depositing the electrically conductive film, patterning the electrically conductive film to form a flexible hybrid electrode of a predetermined shape.
